(19) United States
(12) Patent Application Publication
(10) Pub. No.: US 2004/0231225 A1
(43) Pub. Date: Nov. 25, 2004

(54) Tube fly and tube body for tube fly

(76) Inventor: Shuzo Okada, Sendai-shi (JP)

Correspondence Address: RABIN & Berdo, PC, 1101 14TH STREET, NW, SUITE 500, WASHINGTON, DC, 20005, US

(21) Appl. No.: 10/864,515

(22) Filed: Jun. 10, 2004

Related U.S. Application Data
(62) Division of application No. 10/357,499, filed on Feb. 4, 2003, now abandoned.

(30) Foreign Application Priority Data
Dec. 27, 2002 (JP) 2002-379940
Feb. 5, 2002 (JP) 2002-27731

(51) Int. Cl. A01K 85/00

(52) U.S. Cl. 43/42.36

(57) ABSTRACT

A tube fly formed of assemblable and disassemblable members including a tube body, wherein in assembling the tube fly a decorating member may or may not be placed over the perimeter thereof, a head plug to which a wing member may or may not be provided, a tail plug, a weight member which is selected from a plurality of weight members and is inserted into the tube body, a fly hook, and a connection tube for connecting the tube body and the tube fly hook. The weight member is not used in a case of working the fly near the water surface, but in cases of working the fly in a middle level or a lower level. The head plug and the tail plug are pushed into the ends of the tube body so as to be mounted.

### BACKGROUND OF THE INVENTION

1. Field of the Invention

The invention relates to a tube fly and to a tube body for a tube fly, and particularly to a tube fly wherein a fly includes members that can be both assembled and disassembled, so that the most suitable fly can be assembled in the field according to the type of fish to be caught or the condition of a fishing spot.

2. Description of the Related Art

Conventional tube flies comprise a tube having decorating members such as dyed fibers or the like, on the body portion thereof, to which decorating members wing members made up of feathers or fur are provided. Further, the hook of the fly can be exchanged or replaced, so the tube flies have the advantage that users can use these tube flies many times by exchanging the hook for as long as the tube or the wing member is not damaged, even if the hook is damaged and does not function.

With conventional tube flies, three types of tube materials, i.e., plastic, aluminum and copper, are used, and the speeds at which the different materials sink beneath the water differ from one another, so users select a material according to the desired depth of working the fly. For example, plastic is light and the water resistance thereof is large; therefore, a fly with a plastic tube does not readily sink from its own weight and accordingly is suitable for working the fly at an upper level near the water surface. Aluminum is suitable for working the fly at an intermediate level. In a case of a tube made of copper, a heavy fly can be obtained, and accordingly is suitable for working the fly at a lower level near the bottom of the water.

As for the decorating members, a conventional arrangement is known wherein dyed fibers and/or a glossy film are/is placed over a tube. Such decorating members are bound and fixed with thread.

With conventional tube flies, the structure of decorating members and the color, material, and structure of wing members provided to the outside of a tube are altered according to the type of fish to be caught. Assembly of such flies is a pleasure for an angler. However, the number of types of tube flies fabricated and used is great, and the size of the tube fly differs according to the type of fish to be caught and the condition of the fishing spot. As a result, various sizes and types of materials of tube flies are necessary for each pattern, and there are difficulties in assembling tube flies beforehand even in the event of assembling a simple tube fly.

### SUMMARY OF THE INVENTION

Accordingly, it is an object of the invention to provide a tube fly and a tube body for a tube fly, comprising members that can be assembled and disassembled, wherein an arrangement most suitable for the type of fish to be caught or the condition of the fishing spot can be assembled in the field.

According to a first aspect of the invention, a tube fly includes members that can be assembled and disassembled, wherein the members include a tube body to which a decorating member may or may not be placed over the perimeter thereof, a head plug to which a wing member may or may not be provided, a tail plug, and a weight (weight member) for insertion into the tube body. A user either selects the weight from a plurality of weights and inserts the weight into the tube body, or selects no weight at all and leaves the tube body empty. The head plug is mounted to one end of the tube body and the tail plug is mounted to the other end. A line is passed through the tube body from the head plug and is extended from the tail plug, and a fly hook is connected to the extended line.

The decorating member may be placed over the perimeter of the tube member. A transparent thermal-shrinkable coating tube may be placed over the decorating member, and the transparent coating tube then may be thermally shrunk so as to be tightly fit onto the tube member.

A through hole may be provided in the head plug in an axial direction. A through hole also may be provided in the tail plug in the axial direction.

A groove may be provided at the outside of the tail plug, parallel with the axial direction.

The weight member may be formed of a material that enables a plurality of weight members to be provided, each having a different weight (heaviness).

The tube fly may further include a connector for detachably connecting the fly hook and the line, with the connector being stored in the tube body. Free ends of the connector may be bent back against, and generally parallel to a middle portion, to form two bent portions to which the fly hook and the line respectively can be connected. Both ends of the connector may form holding portions at the point of bending of the bent portions.

The tube fly may further include a slip-preventing member made of rubber or plastic, the slip-preventing member being provided to the interior of the body of the head plug so as to hold the connector by its elasticity.

According to a second aspect of the invention, a tube body for a tube fly includes a tube member, and a decorating member for being placed over the perimeter of the tube member, wherein a head plug is mounted to one end of the tube body and a tail plug is mounted to its other end. A user either selects a weight from among a plurality of weights and inserts the selected weight into the tube body, or selects no weight at all and leaves the tube body empty, such that a tube fly is assembled.

According to the second embodiment, like the first, the decorating member may be placed over the perimeter of the tube member, a transparent thermal-shrinkable coating tube may be placed over the decorating member, and the transparent coating tube then may be thermally shrunk so as to be tightly fit onto the tube member.

With the tube fly according to the invention, the heaviness of the weight is adjusted so that the fly can sink to the level at which the fly is to be worked, the head plug to which the wing member is provided is mounted to one end of the tube body, and the tail plug is mounted to the other end. Manufacture of tube bodies for each pattern of decorating members provides for combinations of the tube bodies and various types of head plugs to which a wing member is provided. Therefore, a user need not assemble the tube flies beforehand, but rather can assemble tube flies according to various types of patterns in the field, selected based upon the type of fish to be caught and the condition of the fishing spot.

With the tube fly according to the invention, in the event of working the fly near the water surface, the weight may be omitted. On the other hand, in the event of working the fly at an intermediate level or a lower level, the heaviness of the weight should be adjusted accordingly.

Furthermore, the tube body according to the invention is different from conventional arrangements in that one tube body works in the same manner as do as conventional plastic tubes, aluminum tubes, and copper tubes, that is by adjusting the amount of the weight. Accordingly, it is not necessary to manufacture tube members of the tube body for each material. Therefore, while several types of patterns of the wing members to be provided to the head plug must be prepared, the number of parts is reduced, so the time of assembly is reduced further as compared with conventional arrangements, and accordingly the amount of preparation performed beforehand can be markedly reduced.

With the tube fly according to the invention, providing a connector for connecting the fly hook and the line facilitates exchanging each part such as the fly hook, head plug, or the like. Particularly, the operations for exchanging of parts do not require cutting the line, thereby facilitating quick exchange of parts required in cases of cold seasons during which operations for binding the line might be difficult, or in the event that the type of fish to be caught is a migratory fish for which the prime fishing season is short.

### BRIEF DESCRIPTION OF THE DRAWINGS

FIG. 1 is a perspective view illustrating the overall tube fly;

FIG. 2 is a perspective view illustrating parts of the tube fly;

FIG. 3 is a cross-sectional view illustrating a tube body;

FIG. 4 is a cross-sectional view illustrating another tube body;

FIG. 5 is a perspective view illustrating a head plug;

FIG. 6 is a perspective view illustrating a tail plug;

FIG. 7 is a perspective view illustrating a weight member;

FIG. 8 is a cross-sectional view illustrating a tube fly according to another embodiment;

FIG. 9 is a perspective view illustrating parts of a tube fly according to the embodiment shown in FIG. 8; and

FIGS. 10A and 10B are cross-sectional views illustrating procedures for exchanging of parts of a tube fly according to the embodiment shown in FIG. 8.

### DESCRIPTION OF THE PREFERRED EMBODIMENTS

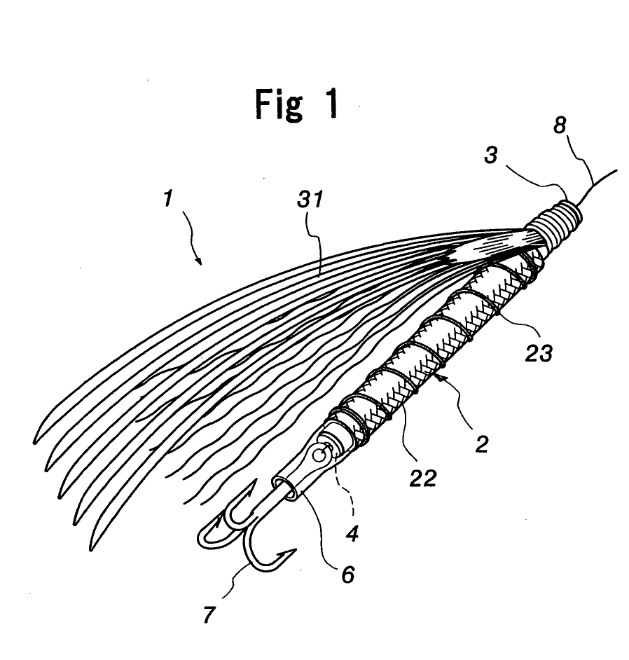

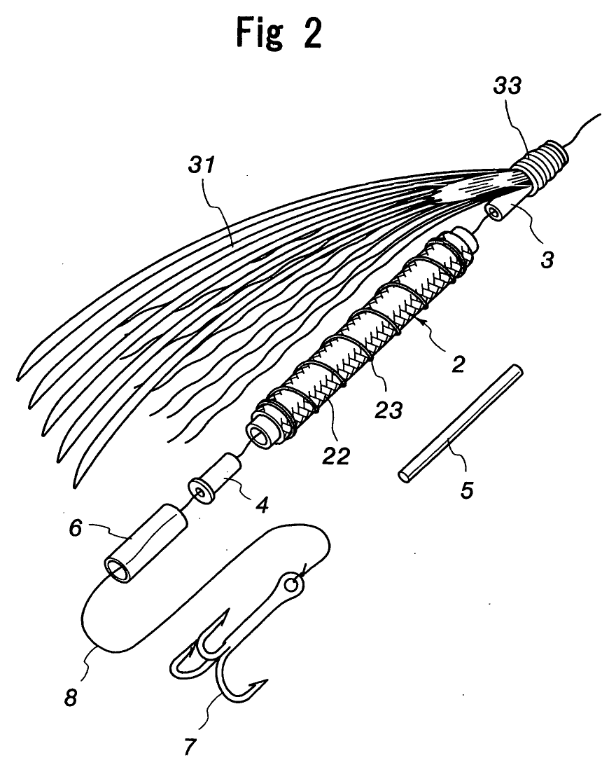

FIG. 1 illustrates an overall configuration of a tube fly, and FIG. 2 illustrates members of the tube fly. In the drawings, a tube fly 1 comprises a tube body 2, a head plug 3, a tail plug 4, a weight (weight member) 5, a connection tube 6, and a fly hook 7.

The tube body 2 has a hollow tube member 21, and a decorating member 22 may or may not be provided to the perimeter of the tube member 21. A wing member 31 may or may not be provided to the perimeter of the head plug 3. Wing members of a build-up type wherein dyed fibers of plastic and/or metal, feather, fur, and so forth, are layered and tied, and a round type wherein the above-described materials are tied uniformly on the entire perimeter of the head plug, are well known. With the present embodiment, a build-up type wing member is shown by way of example. Note that the head plug 3 can be used without the wing member 31. The tail plug 4 is provided so that the weight 5 inserted into the tube body 2 does not fall out.

The weight 5 is inserted into the tube body 2 so as to adjust the overall weight (heaviness) of the tube fly 1. The connection tube 6 is provided so that the fly hook 7 is mounted to the tube body 2, and is made up of silicone rubber or plastic. For the fly hook 7, a single hook, double hook, or triple hook, is selected according to the type of fish to be caught or the condition of the fishing spot. Reference number 8 denotes a line connected to the fly hook 7 through the interior of the tube body 2.

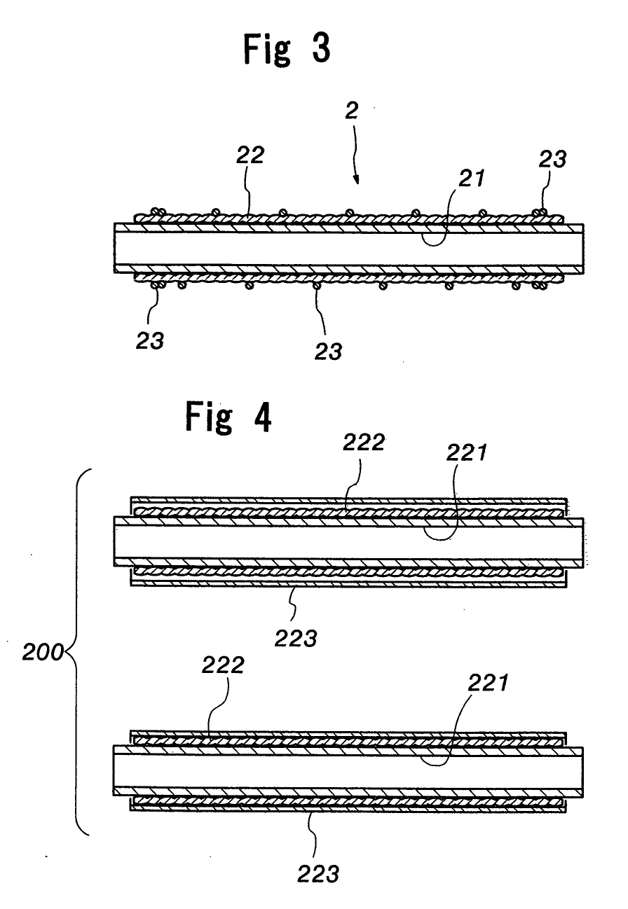

FIG. 3 illustrates a tube body in detail. Referring to the drawing, the tube body 2 makes up the body of the tube fly 1, and the decorating member 22 may or may not be placed over the perimeter of the tube member 21. In the event that the decorating member 22 is placed over the tube member 21, the decorating member 22 is fixed by winding a binding thread 23. A material such as plastic or the like, which is light and can be formed into a thin tube whose interior space is large, is desirable for the tube member 21. The decorating member 22 is made up of dyed fibers, colored fibers of plastic or metal, glossy plastic, plastic containing luminous paint, or the like, designated by each fly pattern specification. Note that in the event that the decorating member 22 is not placed over the tube member 21, the tube member 21 is used as it is, so that its outer surface, which may be colored or not colored, is visible. The binding thread 23 is wound in a spiral manner so as to fix the both ends of the decorating member 22 and to further serve as a decoration. The head plug 3 and the tail plug 4 are pushed in so as to be mounted to the tube body 2. However, in the event that the weight 5 is not used, the tail plug 4 may be omitted and the fly hook 7 may be directly mounted to the tube body 2.

FIG. 4 illustrates a tube body according to another embodiment in detail. Referring to the drawing, a tube body 200 comprises a tube member 221 and a decorating member 222. In the event that the decorating member 222 is an unraveled fiber or a sheet, the procedures for fixing the decorating member by winding a binding thread on the perimeter of the tube member 221 are troublesome. Therefore, with this embodiment, the decorating member 222 is placed over the perimeter of the tube member 221 and fixed with a transparent coating tube 223 that shrinks upon the application of heat. An example of a fixing method is to provide the transparent coating tube 223 over the tube member 221 and decorating member 222, and apply hot air to the transparent coating tube. Thus, by such application of hot air, the transparent coating tube 223 shrinks over the tube member and decorating member, and accordingly the decorating member 222 is tightly fit onto the tube member 221.

With the tube body 2 shown in FIG. 3, the decorating member 22 placed over the perimeter of the tube member 21 is fixed by the binding thread 23, so the length of the completed tube body 2 cannot be adjusted. On the other hand, with the tube body 200 shown in FIG. 4, the transparent coating tube 223 fixes the decorating member 222, so the length of the tube body 200 can be adjusted by cutting off an end portion.

With the embodiments described above, in the event that the weight 5 is not inserted into the tube body (2 or 200), a lightweight fly can be made. In this case, the fly does not readily sink, and accordingly is worked near the water surface, due to the tube member 21 being made from a light material such as plastic. However, in the event that the fly needs to sink quickly such as in deep-sea areas for sea fishing, the tube member 21 itself is made from a heavy material, and the overall weight of the fly can be further increased by inserting the weight 5. Accordingly, the material of the tube member 21 is not restricted to plastic; rather, conventional materials such as aluminum, copper, and so forth, can be used, and a fly that is markedly heavier than a conventional copper tube fly can be obtained by the combination of a copper tube member and a tungsten weight.

Also, a metal coil can be used for the tube member 21. In the case of making up the tube member 21 with a metal coil, an arrangement may be made wherein the transparent coating tube 223 is placed over the perimeter of the metal coil, the transparent coating tube is thermally shrunk, and then the decorating member is placed over the shrunken coating tube and tied by a binding thread. Note that when using the thermally-shrinkable transparent coating tube as a fixing method for the decorating member, an arrangement also may be made wherein the decorating member is placed directly over the metal coil and the transparent coating tube is placed over the perimeter thereof. If the tube member of the tube body 2 or 200 is a metal coil, then effective artificial bait can be obtained due to the flexibility at the body portion of the fly.

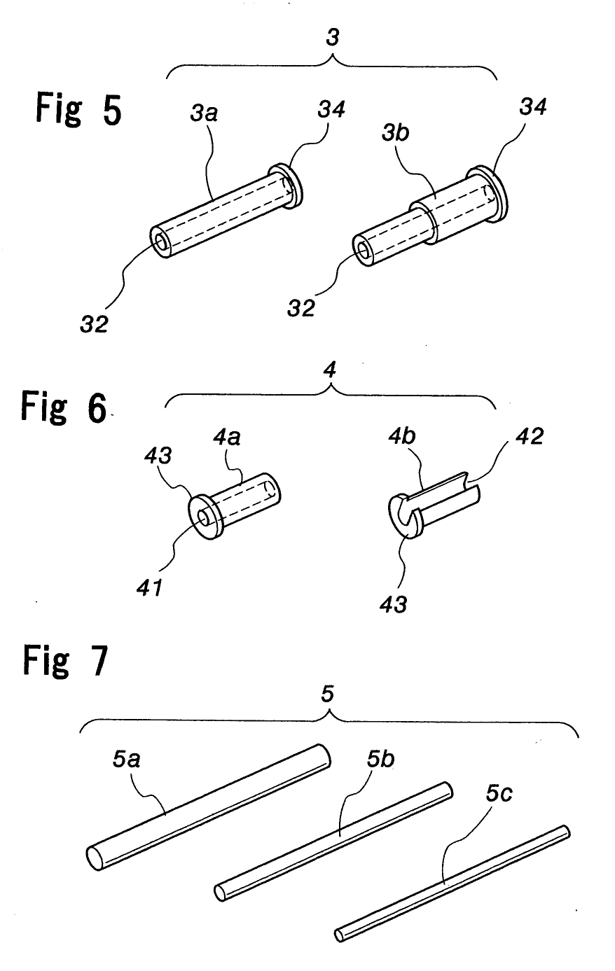

FIG. 5 illustrates a head plug, FIG. 6 illustrates a tail plug, and FIG. 7 illustrates a weight. In these drawings, the head plug 3 is mounted by pushing it into the end of the tube body 2, and has an opening 32 penetrating in the axial direction thereof. The above-described wing member 31 is tied onto the head plug 3 with the binding thread 33 (see FIGS. 1 and 2). The head plug 3 may include as a tube portion either a straight tube head plug 3a or stepped head plug 3b, and a brim-shaped collar 34 may be formed at the end portion to facilitate disassembly of the fly for each type of head plug.

The tail plug 4 is mounted by pushing it into the other end of the tube body 2. The tail plug 4 may be a tube-shaped tail plug 4a by providing a through hole 41 in the axial direction thereof. An alternative tail plug 4b has an arrangement wherein a groove 42 parallel with the axial direction of the tail plug is provided at the outside portion thereof. Note that forming a brim-shaped collar 43 at the end portion of the tail plug 4 also facilitates disassembly of the fly.

The weight member 5 is provided for adjusting the weight (heaviness) of the tube fly 1, and accordingly a material to be used is selected that enables weight members of different heaviness, such as weight members 5a, 5b, and 5c of differing diameter and/or length. The weight 5 is not restricted to a rod-shaped arrangement; rather, coils, chains, pellets or grains, or the like, can be used. With the present embodiment, the weights 5 employ rod members of which their lengths are the same and their diameters differ, and in this case, the weight does not move within the tube body 2, so the attitude of the fly is stable. A user can select whether or not a weight 5 is to be used, and in the event of working the fly in an upper level near the water surface, a weight 5 is not used. A weight 5 is used in the event of working the fly at an intermediate level or a lower level, and the material and the size of the weight are selected so that the fly sinks to the desired level.

In order to assemble the tube fly 1 configured as described above, first, a line 8 is passed in order through the opening 32 of the head plug 3, the tube body 2, the connection tube 6, and the opening 41 of the head plug 4, and then the line 8 is connected to the fly hook 7. The head plug 3 is pushed into the opening end of the tube body 2 with the wing member 31 facing the tube body 2. Next, the selected weight 5 is inserted into the tube body 2 so as to adjust the weight of the tube fly 1 to a desired heaviness, and then the tail plug 4 is pushed into the other opening end of the tube body 2 so that the weight 5 does not fall out from the tube body 2. The portion of the line 8 extending from the head plug 3 is pulled so that the fly hook 7 is fit to the tail plug 4. Then the connection tube 6, through which the line 8 has been passed beforehand, is pushed into the end portion of the tube body 2, such that the fly hook 7 and the tube body 2 are assembled.

In the event that a weight 5 is not used, the tail plug 4 and the connection tube 6 are not used, and the fly hook 7 is directly mounted to the tube body 2.

In the event that the tail plug 4b is used, the line 8 is inserted into the groove 42 provided on the outside, so as to mount the tail plug 4b to the tube body 2. In this case, the procedures of assembling and disassembling can be made easier than the procedures in the case that a line is passed through an opening.

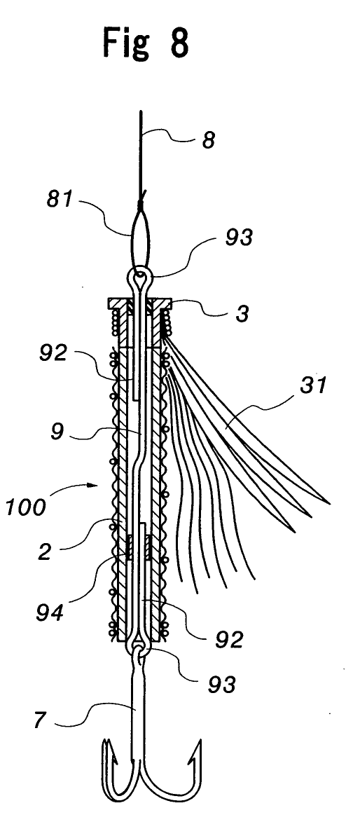

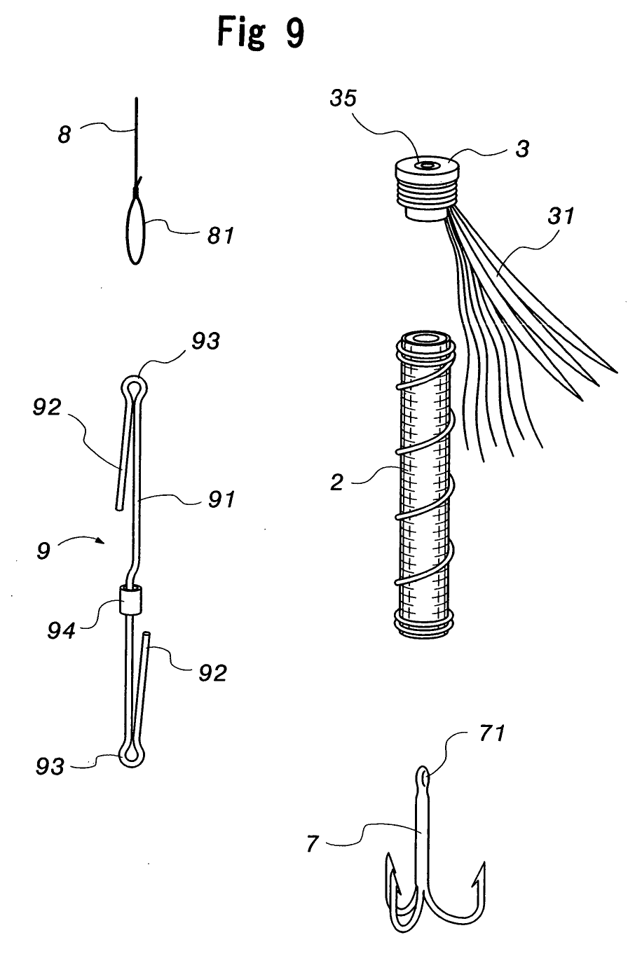

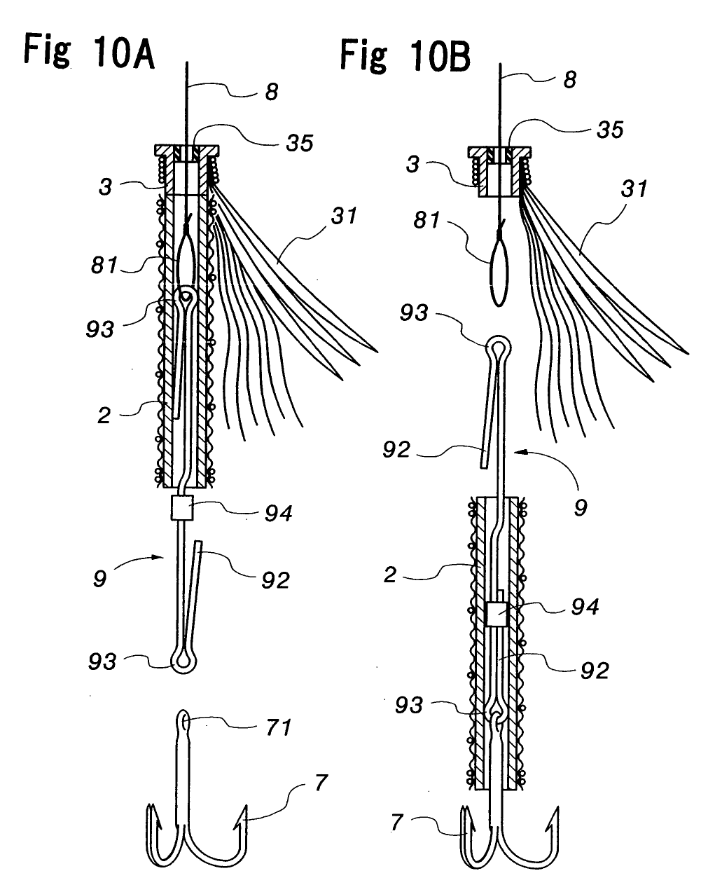

FIG. 8 is a cross-sectional view illustrating a tube fly according to another embodiment, FIG. 9 is a view of the tube fly parts disassembled, and FIGS. 10A and 10B are cross-sectional views illustrating procedures for exchanging parts. The invention relates to an arrangement wherein a fly can be assembled or disassembled. With the present embodiment shown in the drawing, each part, including the fly hook, can be exchanged without cutting the line. In the drawing, a tube fly 100 comprises the tube body 2, the head plug 3, the fly hook 7, and a connector 9.

The present embodiment is different from the preceding embodiment in that the connector 9 is provided for connecting the fly hook 7 with a loop 81 formed at the end of the line 8, and in this case, the tail plug 4 is not used. The connector 9 preferably is made from a rigid material such as metal, carbon resin, reinforced plastic, or the like, and includes a connector body 91, having elastic bent portions 92 and ring-shaped holding portions 93, and a tube-shaped stopper 94. Bent portions 92 are formed by bending back the free ends of a connector body 91 against the middle portion of the connector 9 so as to be generally parallel, while leaving ring-shaped holding portions at the point of bending. As a result of the bending, the connector body has a deformed S-shape as viewed from the front (as shown in FIGS. 8 and 9). Note that ring-shaped holding portions 93 are formed at both ends, and the overall length of the connector is somewhat longer than the tube body 2. The connector 9 is stored within the tube body 2 and connects the fly hook 7 with the loop 81 of the line 8. The tube-shaped stopper 94 is slidably provided on the bent portion 92 where one of the holding portions 93 is connected to the fly hook 7.

While the head plug 3 has an opening for passing through the line 8 as shown in FIGS. 10A and 10B, the present embodiment differs from the preceding embodiment in that the head plug 3 is not arranged to be inserted into the tube body, but is arranged to be connected to one end of the tube body 2. Also, the head plug 3 has at its interior a rubber or plastic slip-preventing member 35. Since the holding portions 93 are elastic (as shown by comparison of FIGS. 8 and 9), the slip-preventing member 35 serves to hold in a slip-preventing manner the bent portion 92 to which the line 8 is connected. Thus, the assembled head plug 3 does not fall out from the tube body 2. While the bent portion 92 at the end of the connector 9 at which the line 8 is connected is held by the slip-preventing member 35 of the head plug 3, the holding portion 93 at that end can be moved against the holding force of the slip-preventing member 35 toward or away from the head plug 3 by application of strong force appropriately directed. The loop 81 formed at the end of the line 8 is connected to the holding portion 93 by inserting the loop from the bent portion 92 of the connector 9.

The fly hook 7 has a ring-shaped portion 71, formed at the tip of its base portion. The ring-shaped portion is used to connect the fly hook to the other holding portion 93.

Now, the procedures of assembling the tube fly 100 will be described. First of all, the loop 81 is formed at the end of the line 8, and is passed through the opening of the head plug 3. The stopper 94 of the connector 9 is put into a neutral position. The ring-shaped portion 71 of the fly hook 7 is inserted onto the bent portion 92 and moved to the holding portion 93. The stopper 94 then is fit to the bent portion 92 at which the fly hook 7 has been mounted.

Also, the other holding portion 93, to which the fly hook 7 has not been mounted, is inserted into the tube body 2 and is extended from the tube body 2. Upon the latter holding portion 93 becoming completely exposed from the tube body 2, the loop 81 of the line 8, which has been passed through the head plug 3, is fit to the bent portion 92, so that the loop 81 is connected to that holding portion 93. When the fly hook 7 has been connected to one holding portion 93, and the other holding portion 93 is connected to the loop 81 of the line 8, the tube fly 100 shown in FIG. 8 is assembled by pushing the connector 9 into the tube body 2 so that the holding portion 93 which has been connected to the loop 81 is somewhat extended from the head plug 3.

Referring to FIGS. 10A and 10B, exchange or replacement of the fly hook 7 and the head plug 3 is explained. For exchange or replacement of the fly hook 7, the fly hook 7 is extracted from the head plug 3 and the tube body 2 along with the connector 9 until the stopper 94 of the connector 9 becomes extended from the tube body 2 as shown in FIG. 10A. The stopper 94 also is slid free the bent portion 92. Then the fly hook 7 is removed from the holding portion 93, which is in a free state, and a new hook is mounted thereto.

For exchanging or replacing the head plug 3 or the tube body 2, the head plug 3 and the tube body 2 are separated one from the other, and the connector 9, to which the loop 81 of the line 8 are connected is extracted from the tube body 2 as shown in FIG. 10B. Here, for exchange or replacement of the head plug 3, the connection of the loop 81 of the line 8 and the connector 9 is freed and the head plug is exchanged or replaced. For exchanging or replacing of the tube body 2, after the connection of the loop 81 of the line 8 and the connector 9 has been freed the tube body 2 is removed from the connector 9. A new desired tube body 2 is fit to the connector 9, and the loop 81 of the line 8 then is reconnected to the connector 9.

1-22 (canceled)

23. A tube fly, comprising:
a tube member;
a decorating member provided on the outer periphery of the tube member; and
a heat-shrinking transparent coating tube covering the decorating member so as to be in close contact with the tube member and decorating member, the decorating member being visually observable through the transparent coating tube.

24. A tube fly according to claim 23, wherein the coating tube is heat shrunk so as to fix the decorating member.

25. A tube fly according to claim 23, wherein the tube member is formed of a lightweight material and is free of weight being inserted therein, so that the tube member does not readily sink in water.

26. A tube fly according to claim 24, wherein the member is formed of plastic.

27. A tube fly according to claim 23, wherein the tube member is formed of a heavy material.

28. A tube fly according to claim 27, further comprising a weight mounted within the tube member.

29. A tube fly according to claim 28, wherein the tube member is formed of copper and the weight mounted therein is formed of tungsten.

30. A tube fly according to claim 23, wherein the tube member is a coil.

31. A tube body for a tube fly, comprising:
a tube member serving as a fly body, wherein the tube member is adapted both
for removable insertion thereinto of a selected one of any of a plurality of weight members of different heaviness, or for selective insertion of no weight member so that the tube body is empty during use of the tube fly, and
for dismountably mounting at one end thereof a head plug, and for dismountably mounting a tail plug at an opposite end thereof, such that either with or without one of the weight members, a fly is assembled;
a decorating member placed over the perimeter of the tube member; and
a transparent coating tube thermally heat-shrunk over the decorating member so as to tightly fit onto the tube member, thereby to hold the decorating member over the tube member with the decorating member visible through the transparent coating tube.
